(19) United States
(12) Patent Application Publication
(10) Pub. No.: US 2009/0100375 A1
(43) Pub. Date: Apr. 16, 2009

(54) Content Navigation Method and User Interface

(75) Inventor: David Kujda, Santa Monica, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/873,381

(22) Filed: Oct. 16, 2007

(51) Int. Cl. G06F 3/048; G06F 3/033; G06F 3/14; G06F 3/00

(52) U.S. Cl. 715/788; 715/856; 715/860; 715/780

(57) ABSTRACT

A content navigation method presents on a screen a number of small boxes, each of which may be a smaller version of another web page or of a portion of a long web page. When a user clicks on a small box, the web page or the portion of a web page corresponding to the small box may be dynamically uploaded and displayed. Accordingly, the user can easily jump to the content in which he/she is interested: another web page or a portion of a long web page.

### CROSS REFERENCE TO RELATED APPLICATIONS

This application is related to U.S. patent application Ser. No. ______, filed on the same day as the instant application and entitled “Method for Presenting a Web Page,” which is hereby incorporated by reference in its entirety.

### BACKGROUND

1. Field of the Invention

The present invention relates generally to the Internet, and more particularly to a method of providing a preview of content on one or more web pages to facilitate navigation.

2. Description of Related Art

The Internet has become a major information resource to users. To attract more users, content providers are putting more and more information on their websites, greatly increasing the quantity and complexity of content of a website. As one consequence, the number of web pages of a website may increase, with each web page providing information/service in one of a number of categories. Users may have to open each web page to find out whether there is any information they are interested in. This process is time consuming.

As another consequence, web pages are becoming longer and longer, with more and more modules stacked thereon, requiring scrolling because a page will not fit on a screen. Users might not think to scroll down to see content on the lower portion of a web page, potentially missing a significant amount of information and services. When a user does scroll down, the upper portion of the web page may move out of the screen, so it is difficult for the user to know all the content on the web page. In addition, constant mouse operation to navigate on a web page can be inconvenient and tiring.

Therefore, it would be desirable to provide a more user friendly content navigation method, which presents a preview of a long webpage or of a number of web pages, so that users may select the content in which they are interested.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates an exemplary environment in which the content navigation method of the present invention may be used.

FIG. 2A illustrates a content navigation user interface according to one embodiment of the present invention.

FIG. 2B illustrates a content navigation user interface according to one embodiment of the present invention.

FIG. 2C illustrates a content navigation user interface according to one embodiment of the present invention.

FIG. 3A illustrates a content navigation user interface according to one embodiment of the present invention.

FIG. 3B illustrates a content navigation user interface according to one embodiment of the present invention.

FIG. 4 illustrates a flowchart of a content navigation method according to one embodiment of the present invention.

FIG. 5 illustrates a flowchart of a content navigation method according to one embodiment of the present invention.

### DETAILED DESCRIPTION

The present invention provides a content navigation method which presents on a screen a first web page and a preview bar. The preview bar may include a number of small boxes, each of which may be filled with a small representation of a second web page or of a portion of the first web page. When a user clicks on a small representation, the second web page or the portion of the first web page corresponding to the small representation may be dynamically loaded and displayed. Accordingly, the user may easily jump to the content in which he/she is interested: the second web page or another portion of the first web page. The present invention gives the user a preview of the content currently out of the screen, so that the user may not miss content he/she is interested in, and may not waste time on content he/she is not interested in. It also saves the user's physical efforts on scrolling up and down a long web page or jumping between web pages. The invention could be carried out by computer-executable instructions, such as program modules. Advantages of the present invention will become apparent from the following detailed description.

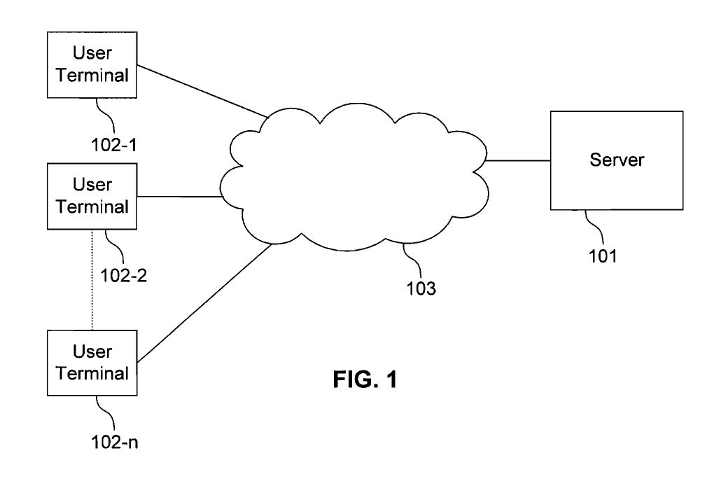

FIG. 1 illustrates an exemplary environment in which the content navigation method of the present invention may be used. As shown, a server 101 may communicate over a network 103 with a number of user terminals 102-1, 102-2, . . . 102-n. The server 101 may be a computer system, which may include one or more of a screen, an input device, a processing unit, a system memory and a system bus coupling various components in the computer system. Network connectivity may be wired or wireless, using one or more communications protocols, as will be known to those of ordinary skill in the art.

The user terminals 102 may be personal computers, handheld or laptop devices, microprocessor-based systems, set top boxes, or programmable consumer electronics. Each user terminal may have a browser application configured to receive and display web pages, which may include text, graphics, multimedia, etc. The web pages may be based on, e.g., HyperText Markup Language (HTML) or extensible markup language (XML).

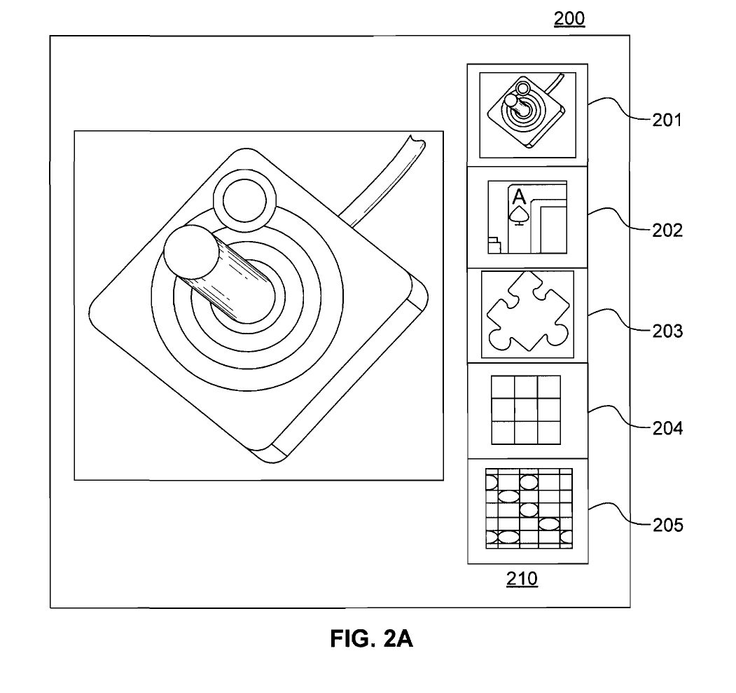

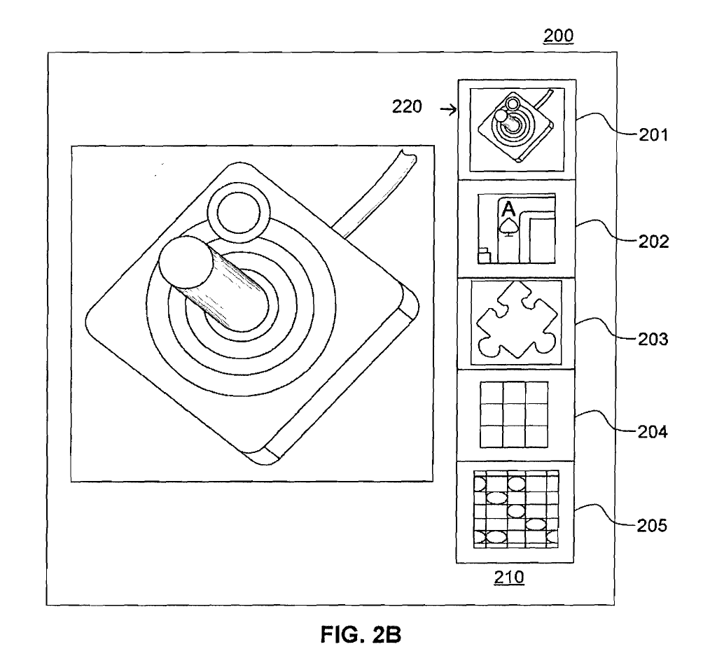

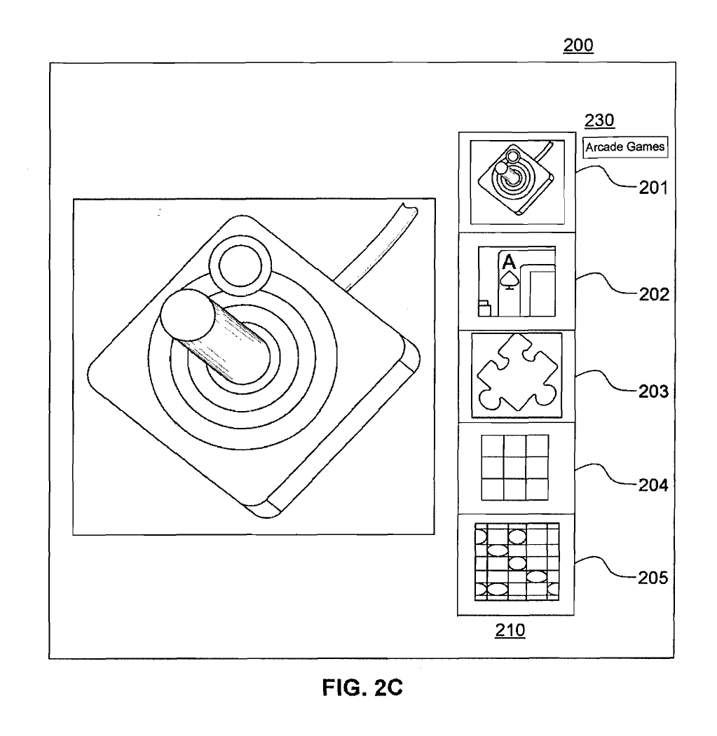

FIG. 2A illustrates a content navigation user interface according to one embodiment of the present invention. In this embodiment, a web page 200 may have five modules, each of which may represent a category of games, e.g., Arcade games 201, Card games 202, Puzzle games 203, Word games 204, and Board games 205. The visual representation of each module (or category) may include an icon for the category and links to the top 3 best selling games in the category. As shown, the screen may be only big enough to display one of the five modules, the module for the category Arcade games. The other four modules may be contained on the same Web page, but lower down, off the screen, requiring the user to scroll down to see each of them.

To help users to realize that the web page 200 may have other modules, on the right hand side of the screen, a content preview bar 210 may be provided. In one embodiment, the content preview bar 210 may include five vertically arranged small boxes: 201, 202, 203, 204 and 205. Each of the small boxes may directly correspond to a larger module of content on the left, and may be filled with a smaller version of the visual representation of the module for a category of games. In other words, a small box may be filled with a small representation of a module, and the preview bar 210 may be thumbnails of modules on a web page. Specifically, the small box 201 may correspond to the module for Arcade games, and may be filled with a smaller version of the visual representation of the module for Arcade games. Similarly, the small box 202 may correspond to the module for Card games, the small box 203 may correspond to the module for Puzzle games, the small box 204 may correspond to the module for Word games, and the small box 205 may correspond to the module for Board games.

The preview bar 210 may provide users an overall image of content on the web page 200. Although only one module is shown on the screen, from the small representations in small boxes 201-205, users may realize that there are four more modules on the web page. Without the preview bar 210, users may only look at the first module, which is shown on the screen, and miss the four modules below the fold.

Through pattern recognition, users may get some ideas about the content of a module by looking at the small representation of the module. In the embodiment shown in FIG. 2A, the visual representation of a module for a category of games includes the icon of this category, and so does the small representation. The user may recognize from the icon that the small representation in the small box 201 corresponds to a module for the category Arcade games. From there, the user may decide whether to look at that module in detail.

If the user is interested in the module for the category Arcade games, the user may hover a mouse pointer or cursor over, or click on the small representation in the small box 201. Consequently, the module for the category Arcade games may be dynamically loaded and displayed on the screen. In the embodiment shown in FIG. 2A, the module of each category of games may include the best selling games in that category, and the best selling games are based on game sales data. Since the sales data may be updated constantly, the modules may be refreshed frequently as well. Each time a user expresses interest in a module, by hovering a mouse pointer or cursor over or clicking on the small representation of the module, that module may be dynamically loaded, and the latest and updated content of that module may be displayed on the screen.

Thus, with the visual relationship between the small representations and the modules, the screen shown in FIG. 2A may give users some indications of the structure of the web page 200 before they actually scroll up and down the web page.

To further facilitate navigation, in one embodiment, the small box corresponding to the module a user is currently looking at may be highlighted to tell the user where he/she is on the long web page 200. In FIG. 2A, the module for the category Arcade games is shown on the screen, and the small box 201, corresponding to the module for the category Arcade games, is highlighted. Accordingly, the user is informed that he/she is at the top of the web page 200. To view other modules on the web page 200, he/she may have to scroll down, but may not scroll up.

FIG. 2B illustrates a content navigation user interface according to one embodiment of the present invention. As shown, an arrow 220 may be provided to point at the small box corresponding to the module a user is currently looking at. When the user is looking at the module for Arcade games, the arrow 220 may point at the small box 201 corresponding to the module for Arcade games. When the user scrolls down to look at the module for Card games, the arrow 220 may move down to point at the small box 202 corresponding to the module for Card games. When the user scrolls up to return to the Arcade games, the arrow 220 may move up to point at the small box 201. In this way, the arrow 220 may track the user's movements along the web page.

FIG. 2C illustrates a content navigation user interface according to one embodiment of the present invention. When a user is hovering the mouse pointer or cursor over a small box, e.g., the small box 201, a text box 230 may be displayed at one side of the small box, and the name of the module corresponding to the small representation in the small box 201, “Arcade games”, may be displayed in the text box. If the user confirms his/her interest in this module by continuing to hover the mouse pointer or cursor over, or clicking on the small box 201, the module for Arcade games may be dynamically loaded, and the most recent content of that module may be displayed. Otherwise, the text box 230 may continue to track the user's movements along the web page, and can load the most recent content of the module in which the user is interested.

The preview bar may be provided at a fixed location on the screen. When a user scrolls up and down a web page, a different module may be displayed on the screen, a different small box may be highlighted, and the arrow 220 or 230 may move to a different location, but the preview bar may stay at the same relative location on the screen. It should be understood that the preview bar may include a greater or lesser number of small boxes, depending on the length of the web page. It should also be understood that the preview bar may be located at other locations on the screen, e.g., on any side of the module being displayed, and in any relative position on the screen, be it upper or lower left or right-hand side, or above or below. While positioning the preview bar above or below the module on the screen may in some circumstances appear to interrupt scrolling on the web page, in one embodiment the preview bar could occupy its own virtual window for display on top of the window in which the module is being displayed. In one embodiment, the user may move the preview bar to a location he/she prefers.

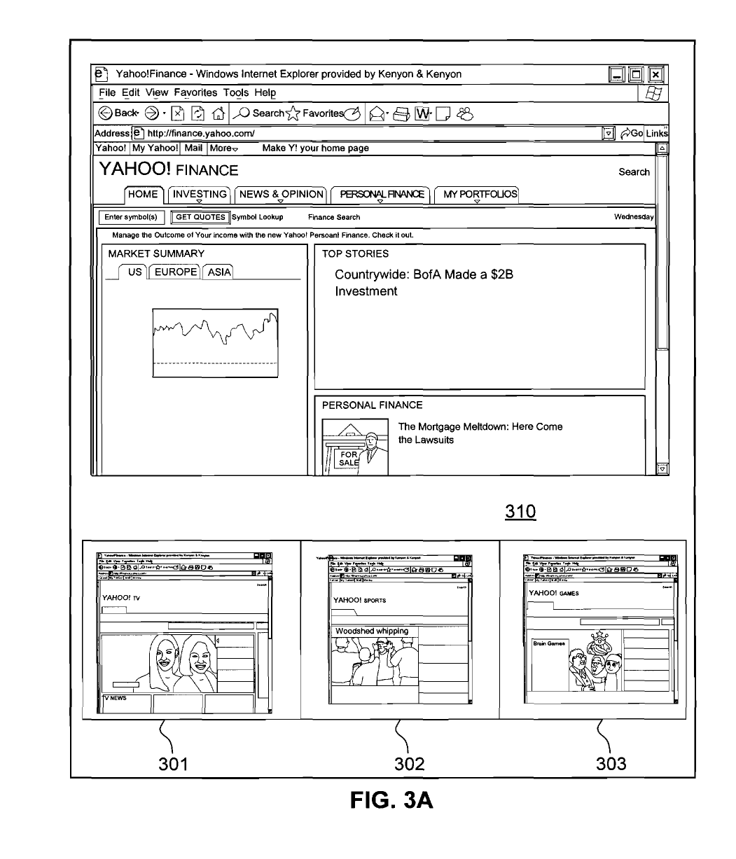

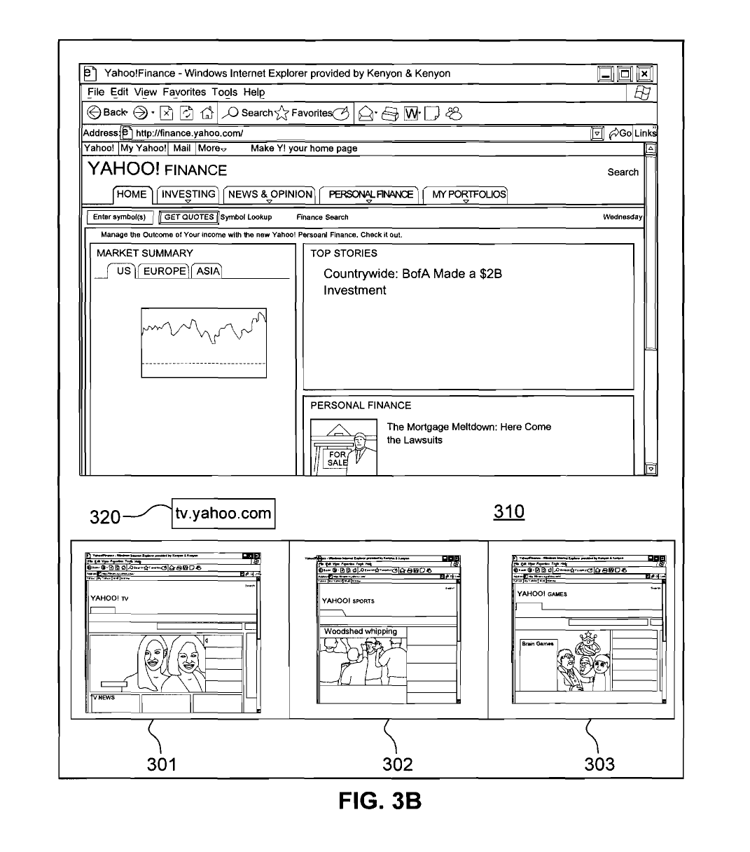

FIG. 3A illustrates a content navigation user interface according to one embodiment of the present invention. On the bottom of the screen, a content preview bar 310 may be provided. The preview bar may include small boxes 301, 302 and 303, each of which may be filled with a small representation of a web page previously selected by a user. For example, if the currently displayed main web page is Yahoo! Finance, the small box 301 may correspond to the web page of Yahoo! TV, and may be filled with a small representation (or thumbnail) of the web page of Yahoo! TV. Similarly, the small box 302 may be filled with a small representation (or thumbnail) of the web page of Yahoo! Sports, and the small box 303 may be filled with a small representation (or thumbnail) of the web page of Yahoo! Games.

The small boxes 301, 302 and 303 may provide users with images of other web pages that the user has previously selected. In one embodiment, each time the user opens a new web page, images in the small boxes 301, 302 and 303 may be refreshed. In another embodiment, images in the small boxes may be refreshed automatically after a certain period of time, e.g., 5 minutes. With pattern recognition, the user may recognize whether there is anything new on these previously selected web pages. If the user is interested in looking at a previously selected web page, e.g., the web page of Yahoo! TV, he/she may hover a mouse pointer or cursor over or click on the small box 301. Consequently, the web page of Yahoo! TV may be dynamically loaded, and the most recent content of that web page may be displayed on the screen.

FIG. 3B illustrates a content navigation user interface according to one embodiment of the present invention. When a user is hovering a mouse pointer or cursor over a small box, e.g., the small box 301, a text box 320 may be displayed at one side of the small box, and the URL (Uniform Resource Locator) of the web page, tv.yahoo.com, may be displayed in the text box. If the user confirms his/her interest in this web page by continuing to hover the mouse pointer or cursor over or clicking on the small box 301, the web page of Yahoo! TV may be dynamically loaded, and the most recent content on that web page may be displayed on the screen. Otherwise, the text box 320 may continue to track the user's mouse movements along the preview bar, and be prepared to load the web page in which the user is interested in.

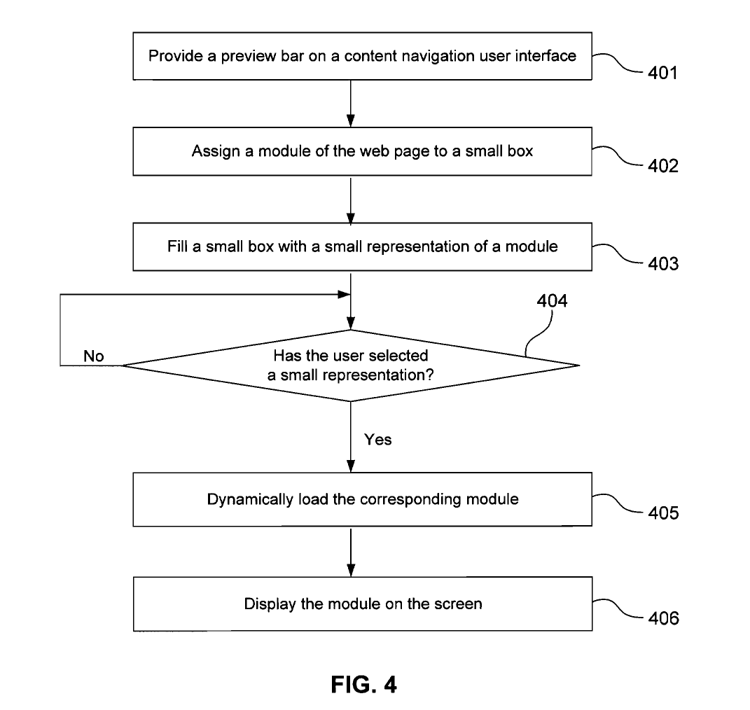

FIG. 4 illustrates a flowchart of a content navigation method according to one embodiment of the present invention. The method shown in FIG. 4 may be used to generate and control the content navigation user interface shown in FIG. 2A, 2B or 2C.

At 401, a preview bar may be provided on a content navigation user interface. At 402, each of the five modules on the web page may be assigned to a small box in the preview bar, with the module for Arcade games being assigned to the small box 301, the module for Card games being assigned to the small box 302, the module for Puzzle games being assigned to the small box 303, the module for Word games being assigned to the small box 304, and the module for Board games being assigned to the small box 305.

At 403, each of the small box may be filled with the small representation of the assigned module when loading the web page. The small boxes may be filled before the web page is displayed, or at the same time the web page is displayed.

At 404, it is decided whether the user has selected any of the small representations in the preview bar. The user may select a small representation by continuing to hover the mouse pointer or cursor over the small representation, or by clicking on the small representation.

If the user has selected a small representation, the corresponding module may be dynamically loaded at 405, and the most recent content of the module may be displayed on the user interface, or a screen, at 406.

In one embodiment, at 406, the small box containing the selected small representation may be highlighted.

In one embodiment, at 404, an arrow may be provided at one side of the small box the user is hovering the mouse pointer or cursor over.

In one embodiment, at 404, when the user is hovering the mouse pointer or cursor over a small representation, a text box may be presented at one side of the small box containing the small representation, with the name of the corresponding module being displayed in the text box.

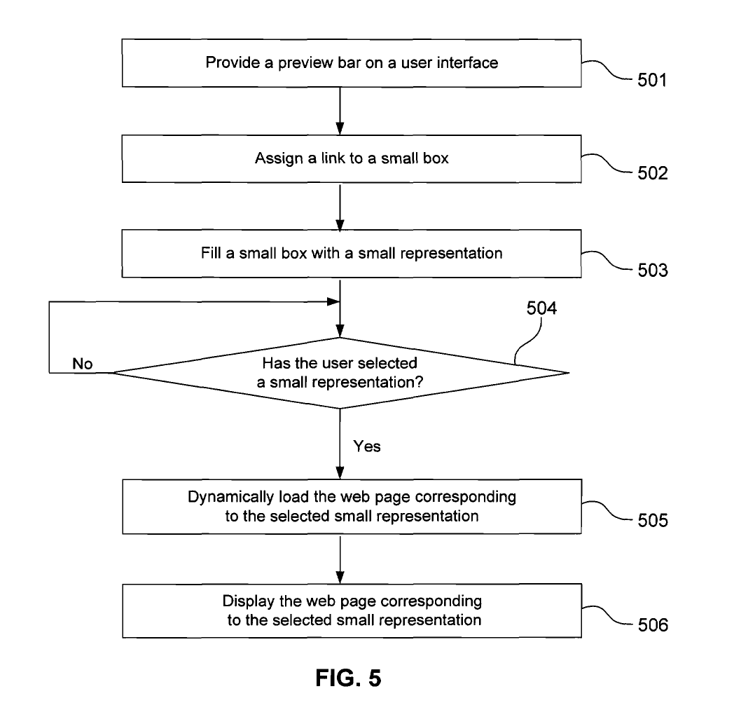

FIG. 5 illustrates a flowchart of a content navigation method according to one embodiment of the present invention. The method shown in FIG. 5 may be used to generate and control the content navigation user interface shown in FIG. 3A, 3B or 3C.

At 501, a preview bar may be provided on a content navigation user interface. The preview bar may have a number of small boxes. At 502, a link to a web page may be assigned to a small box in the preview bar. In one embodiment, a link to a web page is assigned to a small box when a user fills the small box with a URL. For the user interface in FIG. 3A, the link to the web page of Yahoo! TV may be assigned to the small box 301, the link to the web page of Yahoo! Sports may be assigned to the small box 302, and the link to the web page of Yahoo! Games may be assigned to the small box 303. In one embodiment, links to a number of most recently viewed web pages in a user's browsing history may be assigned to the small boxes.

At 503, each of the small boxes may be filled with a small representation of the web page assigned. The small boxes may be filled during the process for loading a main web page, e.g., Yahoo! Finance.

At 504, it is decided whether a user has selected any of the small representations in the preview bar. The user may select a small representation by hovering the mouse pointer or cursor over the small representation, or by clicking on the small representation.

If the user has selected a small representation, the corresponding web page is dynamically loaded at 505, and the most current content of the web page may be displayed on the user interface at 506.

It should be understood that a content navigation user interface may include both small representations for modules of the currently displayed main web page and small representations of other web pages previously selected by the user.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method comprising:
presenting a smaller version of a visual representation of at least part of a web page in a first display area of a user interface;
determining whether a user has selected the smaller version of the representation;
dynamically uploading an updated version of the representation when the user has selected the smaller version of the representation; and
displaying the updated version of the representation in a second display area of the user interface.

2. The method of claim 1, wherein the representation is a visual representation of the entire web page.

3. The method of claim 1, wherein the representation is a visual representation of a module of the web page.

4. The method of claim 1, wherein the user selects the smaller version of the representation by hovering a mouse pointer or cursor over the smaller version of the representation.

5. The method of claim 1, wherein the user selects the smaller version of the representation by clicking on the smaller version of the representation.

6. The method of claim 1, further comprising highlighting the smaller version of the representation when the user has selected it.

7. The method of claim 1, further comprising providing a pointer pointing at the smaller version of the representation when the user has selected it.

8. The method of claim 1, further comprising providing a text box to the smaller version of the representation.

9. The method of claim 2, wherein the web page is a recently viewed web page in a user's browsing history.

10. A computer program product having program code, contained in a computer-readable medium, for performing the method of claim 1.

11. A user interface, comprising:
a first display area for displaying a toolbar, wherein the toolbar comprises at least two small boxes, each of which is filled with a smaller version of a visual representation of at least part of a web page; and
a second display area for displaying an updated version of the representation in full size,
wherein when a user has selected a smaller version of the representation, an updated version of the representation is dynamically uploaded and displayed in the second display area.

12. The user interface of claim 11, wherein the representation is a visual representation of the entire web page.

13. The user interface of claim 11, wherein the representation is a visual representation of a module of the web page.

14. The user interface of claim 11, wherein the first display area allows a user to select a smaller version of the representation by hovering a mouse pointer or cursor over the smaller version of the representation.

15. The user interface of claim 11, wherein the first display area allows a user to select a smaller version of the representation by clicking on the smaller version of the representation.

16. The user interface of claim 11, wherein a smaller version of the representation is highlighted when it is selected.

17. The user interface of claim 11, further comprising a pointer pointing at a smaller version of the representation when it is selected.

18. The user interface of claim 11, further comprising a text box displayed at one side of a smaller version of a representation when a user points at the smaller version of the representation.

19. The user interface of claim 12, wherein the web page is a recently viewed web page in a user's browsing history.

20. The user interface of claim 11, wherein the first display area is substantially smaller than the second display area.
